(19) United States
(12) Patent Application Publication
(10) Pub. No.: US 2025/0125559 A1
(43) Pub. Date: Apr. 17, 2025

(54) CONNECTOR

(71) Applicant: HUBER+SUHNER AG, CH-9100 HERISAU (CH)

(72) Inventor: Franz MANSER, Herisau (CH)

(73) Assignee: HUBER+SUHNER AG, CH-9100 HERISAU (CH)

(21) Appl. No.: 18/912,784

(22) Filed: Oct. 11, 2024

Related U.S. Application Data
(60) Provisional application No. 63/543,738, filed on Oct. 12, 2023.

(51) Int. Cl. H01R 13/627; H01R 24/40; H01R 103/00

(52) U.S. Cl. CPC H01R 13/6277; H01R 24/40; H01R 2103/00

(57) ABSTRACT

A connector including a base element extending along a longitudinal axis from a proximal end, configured to be interconnected to a cable, to a distal end, configured to mate with a mating connector. The connector includes an outer sleeve arranged circumferentially around the base element and moveable between an unlocked position and a locked position, or vice versa. A spring element includes a first end interconnected to the base element and a second end engageable with the mating connector. The outer sleeve axially moves from the unlocked position to the locked position, in which the outer sleeve acts on the spring element so that the second end of the spring element engages with the mating connector for holding the mating connector in a mated state against a pull-out force. The outer sleeve rotates around the longitudinal axis to be axially secured in the locked position.

### CROSS-REFERENCE TO RELATED APPLICATION

This application claims the benefit of U.S. Provisional Patent Application, Ser. No. 63/543,738, filed on 12 Oct. 2023. The co-pending provisional application is hereby incorporated by reference herein in its entirety and is made a part hereof, including but not limited to those portions which specifically appear hereinafter.

### FIELD OF THE DISCLOSURE

The present disclosure relates to a connector for mating with a mating connector, a coaxial connector assembly as well as a method for establishing a connection between a connector and a mating connector.

### BACKGROUND OF THE DISCLOSURE

For outdoor applications of plug connectors, such as in base stations or antennas of mobile radio networks, on ships, for industrial cable installations or the like, where harsh environmental conditions prevail, connectors, which match the requirements in terms of application and behavior are available under the designation Outdoor Connector. Known connectors, which are designed for water-tight and dust-tight connections, comprise screw locks, in which a union nut attached to a connector portion is screwed onto an external thread arranged on the mating connector, for securing the connection in the inserted state.

Such screw lock systems have various disadvantages, as the reliability of the lock is limited because the screw connection can be released, if vibrations or the like occur. In particular, the quality of the screw connection depends on whether the union nut is screwed correctly onto the thread; consequently, mounting defects can arise. The screw lock requires a significant amount of time for establishing the connection, which is of particular of relevance if a larger number of connections needs to be established at one location. In addition, specific tools (e.g. a torque wrench) are needed, which causes additional costs and effort necessary for the correct screw connection with predefined tightening torque. In order to provide tools with sufficient access to the screw connection, the minimum distance between neighboring connections must be chosen to be large enough for the achievable connector density to be limited thereby. As these disadvantages are known, connections which are locked by means of a spring have been developed. One example can be found in EP1094565A1.

EP1094565A1, published on 25 Apr. 2001 on behalf of the applicant, relates to a plug connector, which comprises a housing for plugging in a counter plug, a through channel for an insulated inner conductor contact and an arrangement for mechanically connecting the plug housing and counter plug. The counter plug is latched by the connecting arrangement when the plug connector is connected to it. The connecting arrangement exerts axial tension on the counter plug to clamp outer conductor contact surfaces of the counter plug and plug connector together.

### SUMMARY OF THE DISCLOSURE

Spring based connector types as shown by EP1094565A1 have several advantages over screw lock systems. The connecting arrangement is designed to exert an axial tension on the counter plug to clamp an outer conductor contact surface of the counter plug against an outer conductor contact surface of the plug connector. Establishing such a connection is fast and can be done without additional tools. The shown connection assembly comprises a connector and a mating connector. The connector has a connector housing with a clamp sleeve and a sliding sleeve, that can be moved axially to mechanically connect the connector housing with the mating connector. The sliding sleeve typically surrounds the clamp sleeve in the operating position and exerts on it a force directed radially inward in the operating position. The clamp sleeve is designed to rest against the mating plug at a clamp surface, with an outer conductor contacting the surface of the mating plug, being clamped axially against an outer conductor contact surface of the connector plug. The disadvantage of these clamp solutions however is, that under an axial load, the connection can be unintentionally unlocked. Pulling the connector in axial direction can cause the sliding sleeve to release the clamp sleeve and thereby release the engaged spring fingers, which can cause the connection to be unintentionally released.

An objective of the present disclosure can be seen in providing a connector of the above-mentioned type which provides a more reliable connection against full-out forces and unintendedly releasing the lock. The connection should still be facile to establish.

The present disclosure relates to a connector for mating with a mating connector. The connector typically comprises a base element, which extends along a longitudinal axis from a proximal end to a distal end. The proximal end is typically configured to be interconnected to a cable. The cable can be either attached to the proximal end of the base element or the proximal end may comprise a receiving space for receiving an end of a cable.

The distal end is typically configured to mate with the mating connector. The distal end may be tubular and can comprise a conical lead-in for centering and receiving spring elements of a mating connector. The distal end may further comprise a circumferential recess for receiving a sealing element, e.g. an O-ring or the like. This sealing element may be configured to seal the connection of connector and mating connector against environmental influences.

The connector is typically essentially rotational symmetrical. The base element may be tubular and comprise a through hole extending along the longitudinal axis. The connector further typically comprises an outer sleeve, which is arranged circumferentially around the base element and is configured to be moved with respect to the base element between an unlocked position and a locked position or vice versa. The outer sleeve may be guided in axial direction by a cylindrical outer surface of the base element. The outer sleeve can compromise a guide in form of a bulge. The bulge may protrude adjacent to a proximal end of the outer sleeve towards the longitudinal axis. The guide typically interacts with the cylindrical outer surface. The outer sleeve can at a distal end comprise locking means which are configured to engage the mating connector.

The connector further typically comprises at least one spring element, which comprises a first end which is interconnected to the base element and a second end which is configured to engage with the mating connector. The first end of the spring element may be arranged in a groove of the base element. The groove may be in form of a circumferential recess. The outer sleeve may be configured to be axially moved from the unlocked position to the locked position, in which the outer sleeve acts on the spring element so that the second end of the spring element engages with the mating connector for holding the mating connector in a mated state against a pull-out force. In a preferred embodiment the spring element is encompassed by the outer sleeve. In the unlocked position the second end of the spring element typically extends away from the longitudinal axis. In the locked position the second end of the spring element is typically deflected towards the longitudinal axis by the outer sleeve.

Good results can be achieved if in the locked position the second end of the spring element engages a groove in the mating connector and thereby attaches the base element to the mating connector. The spring element ensures that the connector latches with the mating connector during interconnecting the connector to the mating connector. This ensures that before bringing the outer sleeve into the locked position, the connector is already secured against an axial load through the engaged spring element. In this position, the connector can hold the weight of the cable assembly but can still be pulled off again by the operator to separate the connection. Once the outer sleeve is in the locked position, the spring element exerts its full holding force. The connector can then usually not be pulled off the mating connector anymore.

The outer sleeve may further be configured to be rotated around the longitudinal axis to be axially secured in the locked position. The outer sleeve is in the unlocked position typically arranged adjacent to the proximal end of the base element and configured to be axially moved to the locked position towards the distal end of the base element. In the locked position, the second end of the spring element typically engages the mating connector. In a preferred embodiment the second end of the spring element comes to rest in a groove of the mating connector.

The spring element may in the locked position of the outer sleeve be deflected and form an undercut with the mating connector for holding the mating connector in a mated state. The outer sleeve can comprise a locking means, which is configured to engage the mating connector through the rotation to axially secure the outer sleeve in the locked position. Good results can be achieved, when the outer sleeve is subsequently to the axial movement rotated so that the locking element of the outer sleeve engages a complementary locking element at the mating connector. Alternatively, the axial movement and the rotational movement may be superimposed. The connector is thereby in the axial direction secured with respect to the mating connector against an axial pull out force.

The spring element may at least be partially arranged between the base element and the outer sleeve and the second end is deflected by a functional surface of the outer sleeve. The functional surface may at least partially have the shape of a truncated cone. The smaller diameter of the truncated cone typically faces the proximal end of the base element whereas the larger diameter of the truncated cone typically faces the distal end of the basement.

The functional surface can comprise a first functional area and a second functional area, which functional areas are both in the shape of a truncated cone, with the first functional area comprising a steeper slope angle than the slope angle of the second functional area. In the unlocked position the spring element typically interacts with the first functional area whereas in the locked position the spring element interacts with the second functional area. By axially displacing the outer sleeve towards the distal end of the base element the spring element is forced from the first functional area into the second functional area. With a rotation while the pin is in the steeper slope the sleeve moves faster in axial direction while in the less steep slope it moves slower but generates a higher axial force when the spring element is to be pushed in the locked position.

The spring element is thereby compressed and exerts a superimposed axial and radial force onto the mating connector. The spring element can be an at least partially circumferential spring ring comprising a C-shaped structure along the longitudinal axis. The first end of the spring ring can be arranged in a circumferential recess in the base element. The second end of the spring ring may be foreseen to engage the mating connector. The spring ring may comprise an apex between the first end and the second end, which apex engages with the functional surface of the outer sleeve. During the axial motion the outer sleeve may be configured to move the apex of the spring ring from the first functional area to the second functional area, whereby the spring ring is compressed by the second functional area. In a variation the outer sleeve can be a multi piece part.

In such a design the outer sleeve can comprise at the proximal end an anti-rotation means, which in the locked position engages a recess in the base element. The outer sleeve can be made from two parts, preferably an inner sleeve and a outer sleeve. The inner sleeve typically comprises the functional surface on the inner side. The anti-rotation means can be in form of two protrusions arranged with respect to the longitudinal axis opposite to each other and during the movement of the outer sleeve from the unlocked position into the locked position slide over the outer surface of the base element before engaging the recess in the locked position. The base element may comprise a cylindrical section which comprises at least one recess. The deflection element may comprise at least one thereto corresponding protrusion. During the axial movement along the longitudinal axis, the at least one protrusion engages the at least one recess and prevents a relative rotational movement.

In an alternative embodiment, the spring element is an at least partially circumferential spring cage comprising a tubular base and a number of spring lugs extending away from the base along the longitudinal axis. The spring element may be made by stamping and bending or may alternatively be machined preferably turned or milled. The tubular base can be in form of a cylindrical ring. Each of the number of spring lugs may comprise an elastic stay being at a proximal end attached to the tubular base and comprising at a distal end a projection.

The distal ends of the lugs can be bent away from the longitudinal axis. The projection of each of the lugs typically projects towards the longitudinal axis. In addition, the spring cage can comprise at least one protrusion which extends radially away from the tubular base and in the locked position engages a window or a pocket in the outer sleeve. The protrusion typically serves the purpose of securing the outer sleeve in the locked position with respect to the longitudinal axis.

Good results can be achieved, when the outer sleeve comprises a slot guide extending at least partially circumferential from a first pocket to a second pocket. The pockets may each be configured to secure the outer sleeve in the unlocked position respectively the locked position. Securing the outer sleeve especially in the locked position with respect to the longitudinal axis ensures that the spring element properly engages the mating connector. The guiding along the slot and securing the outer sleeve in the locked respectively unlocked position can be realized by pins. Two pins may be arranged in bores in the base element and may extend radially away from the longitudinal axis. The two pins are preferably arranged opposite to each other with respect to the longitudinal axis.

The slot guide may comprise a first segment extending from the first pocket to a second segment extending to the second pocket, with the angle of the first segment being steeper than the angle of the second segment with respect to the longitudinal axis. The slot guide causes superimposed axial and rotational movement of the outer sleeve with respect to the longitudinal axis. To support pushing the sleeve in the unlocked position towards the proximal end of the base element, and for holding the sleeve in the unlocked position, some of the spring lugs, e.g. 3 or 4, may be bent slightly outwards from the longitudinal axis, so that they push against the functional surface and generate a force on the sleeve. Such a frictional or axial force can be sufficient to position the outer sleeve with respect to the base element in the unlocked position. The slot guide 8 can also be shaped with a continuously changing slope angle.

The present disclosure further relates to an alternative embodiment of a connector. The connector for mating with a mating connector may comprise a base element which extends along the longitudinal axis from a proximal end being configured to receive a cable to a distal end being configured to mate with the mating connector. The base element may be designed as the base element of the first embodiment described above noted. The connector further comprises an outer sleeve, which is arranged circumferentially around the base element and configured to be moved with respect to the base element between an unlocked position and a locked position.

The connector further comprises at least one spring element, which comprises a first end which is interconnected to the base element and a second end which is configured to engage with the mating connector. The outer sleeve may be configured to be rotated around the longitudinal axis from the unlocked position to the locked position, in which the outer sleeve acts on the spring element for the second end of the spring element to engage with the mating connector to hold the mating connector in a mated state against a pull-out force. The movement between the unlocked and the locked position can be a combined axial and rotational movement. Alternatively, the movement between the unlocked and the locked position can be a rotational movement, without an axial movement.

The spring element may be at least partially arranged between the base element and the outer sleeve and the second end is deflected by a functional surface of the outer sleeve. The outer sleeve can comprise protrusions extending towards the longitudinal axis, each comprising a functional surface which in a cross-sectional view along the longitudinal axis is at least partially inclined with respect to a tangential direction. The outer sleeve may comprise circumferentially at its inner side first grooves and second grooves, which extend parallel to the longitudinal axis, whereby the first grooves are deeper than the second grooves. The first grooves and the second grooves may be arranged in alternating manner. Between each first groove and each second groove a protrusion may be arranged.

In the cross-sectional view along the longitudinal axis each protrusion may have an essentially triangular layout. By rotating the outer sleeve from the unlocked into the locked position the spring element is compressed by the second grooves. The protrusions prevent the spring element from disengaging under an axial load. In the unlocked position, the second ends of the spring elements may be movably arranged in the first grooves and in the locked position the second ends of the spring elements are typically deflected and form an undercut for holding the mating connector in a mated state.

The connector according to the present disclosure may be a coaxial connector with the base element being the outer conductor and an inner conductor being arranged within the base element, spaced apart by a dielectric spacer element. The inner conductor may be in form of a pin which at the proximal end comprises a receiving space for an inner conductor of a coaxial cable. The dielectric spacer may be in the form of a cylindrical sleeve which is arranged within the base element and configured to receive the inner conductor.

The present disclosure further relates to a coaxial connector assembly comprising a connector as described herein above and a mating connector. It further relates to a method for establishing a connection between a connector as described herein above and a mating connector.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims.

FIG. 1 is a lateral sectional view of a first embodiment of the connector in an unlocked position.

FIG. 2 is a lateral sectional view of the first embodiment of the connector according to FIG. 1 in a locked position.

FIG. 3 is a perspective and partially sectionized view of the first embodiment of the connector according to FIG. 1 in the unlocked position.

FIG. 4 is a perspective, partially sectionized and exploded view of the first embodiment of the connector according to FIG. 3.

FIG. 5 is a lateral sectional view of a second embodiment of the connector in the unlocked position.

FIG. 6 is a lateral sectional view of the second embodiment of the connector according to FIG. 5 in the locked position.

FIG. 7 is a perspective and partially sectionized view of the second embodiment of the connector according to FIG. 5 in the unlocked position.

FIG. 8 is a perspective partially sectionized and exploded view of the second embodiment of the connector according to FIG. 7.

FIG. 9 is a lateral sectional view of a third embodiment of the connector in the unlocked position.

FIG. 10 is a lateral sectional view of the third embodiment of the connector according to FIG. 9 in the locked position.

FIG. 11 is a lateral view of the third embodiment of the connector according to FIG. 9 in the unlocked position.

FIG. 12 a perspective and partially sectionized view of the third embodiment of the connector according to FIG. 9.

FIG. 13 is a perspective partially sectionized and exploded view of the third embodiment of the connector according to FIG. 9.

FIG. 14 is a perspective view of the spring element of the third embodiment of the connector according to FIG. 9.

FIG. 15 is a perspective view of an alternative embodiment of the spring element according to FIG. 14.

FIG. 16 is another lateral view of the third embodiment of the connector according to FIG. 9 in the unlocked position.

FIG. 17 is a lateral sectional schematic illustration of a fourth embodiment of the connector in the locked position.

FIG. 18 is a lateral sectional schematic illustration of a fifth embodiment of the connector in the locked position.

FIG. 19 is a sectional schematic illustration of a sixth embodiment along the longitudinal axis in the unlocked position.

FIG. 20 is a sectional schematic illustration of the sixth embodiment according to FIG. 17 in the locked position.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

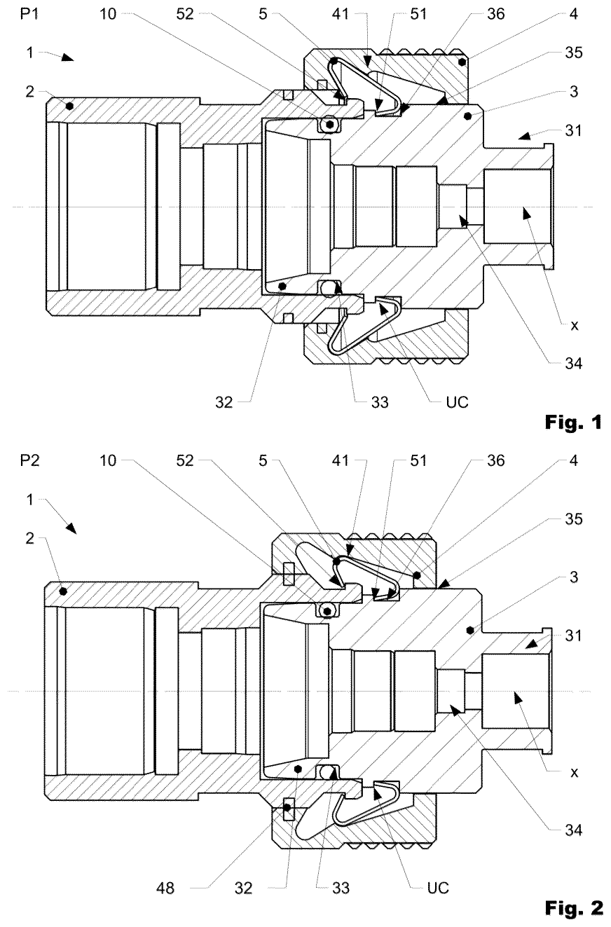

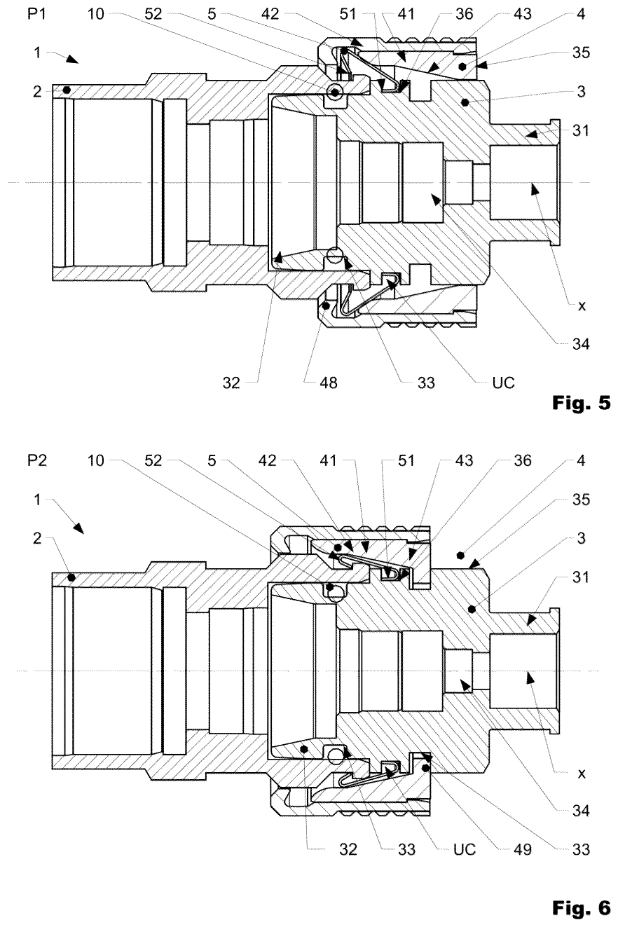

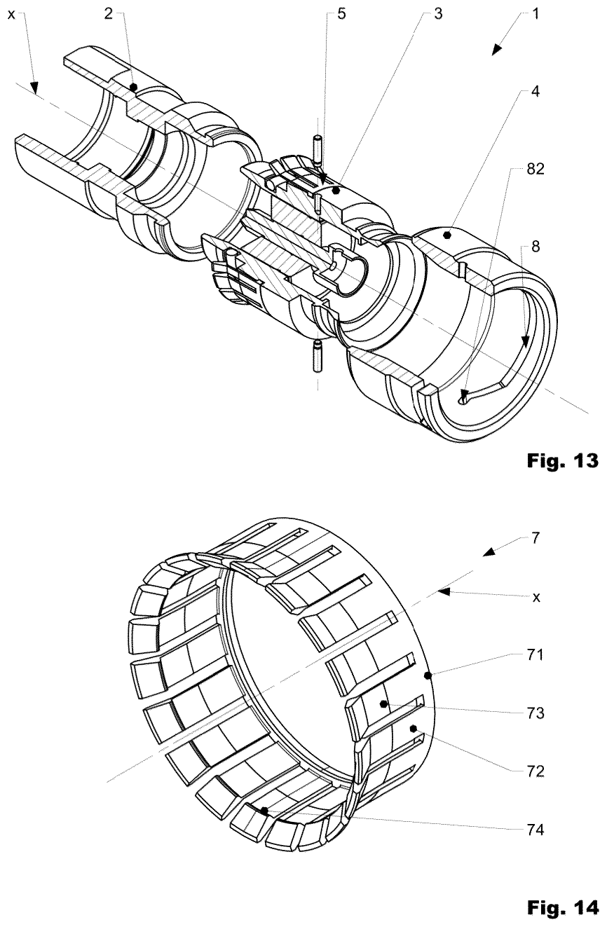

FIGS. 1 to 16 relate to embodiments of the connector 1 with an outer sleeve 4 which is configured to be axially moved and in addition be rotated around the longitudinal axis x. As can be obtained from FIGS. 1 and 2, as well as FIGS. 5 and 6 and FIGS. 9 and 10, the shown connectors 1 may be connected to a mating connector 2. The connectors 1 each comprise a base element 3, which extends along the longitudinal axis x from a proximal end 31 to a distal end 32. The proximal end 31 is configured to be interconnected to a cable. The shown proximal ends 31 each comprise a receiving space for receiving the cable. The distal end 32 is configured to mate with the mating connector 2. The shown distal ends 32 comprise a bulge each, which comprises a conical lead-in for centering and receiving the spring elements (not shown) of the mating connectors 2. The distal ends 32 further comprise a circumferential recess 33 for receiving a sealing element 10, such as an O-ring as in the shown embodiments. The O-ring is configured to seal the connection of connector 1 and mating connector 2 against environmental influences.

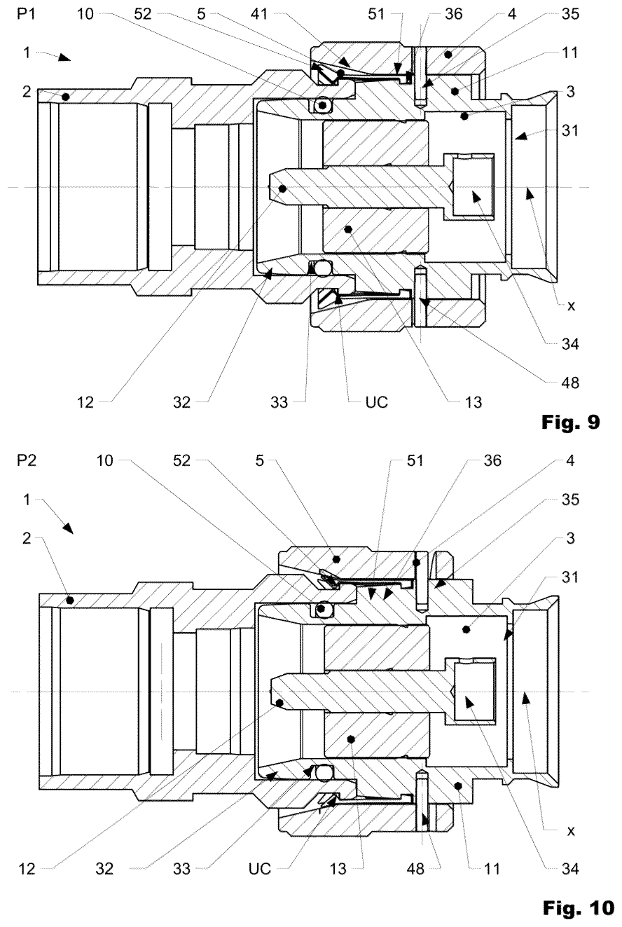

As can be seen from FIGS. 9 and 10, the shown embodiments of the connector 1 are foreseen as coaxial connectors, with a tubular base element 3, which is the outer conductor 11, and an inner conductor 12 which is arranged within the tubular base element 3, spaced apart by a dielectric spacer element 13. The inner conductor 12 is in form of a pin which at the proximal end comprises a receiving space for an inner conductor of a coaxial cable. The dielectric spacer 13 is in form of a cylindrical sleeve which is arranged within the base element 3 and configured to receive the inner conductor.

The shown connectors 1 are rotational symmetrical. The base elements 3 are tubular and comprise a through hole 34 which extends along the longitudinal axis x. The connectors 1 further comprise an outer sleeve 4, which is arranged circumferentially around the base element 3 and configured to be moved with respect to the base element 3 between an unlocked position P1 and a locked position P2. The outer sleeves 4 are guided in axial direction by a cylindrical outer surface 35 of the base element 3.

All embodiments of the shown connectors 1 further comprise spring element 5. Each of the spring elements 5 comprises a first end 51, which is interconnected to the base element 3 and a second end 52, which is configured to engage with the mating connector 2. The first end 51 of the respective spring element 5 may be arranged in a groove 36 of the base element 3. The grooves 36 are in form of a circumferential recess. The outer sleeves 4 are configured to be axially moved from the unlocked position P1 to the locked position P2. In the locked position P2, the outer sleeve 4 acts on the spring element 5 so that the second end 52 of the spring element 5 engages with the mating connector 2 for holding the mating connector 2 in a mated state.

In the unlocked position P1, the second end 52 of the spring element 5 extends away from the longitudinal axis x. In the locked position P2, the second end 52 of the spring 5 is deflected towards the longitudinal axis x by the outer sleeve 4. The outer sleeve 4 is further configured to be rotated around the longitudinal axis x to be axially secured in the locked position P2. The respective outer sleeve 4 is in the unlocked position P1 arranged adjacent to the proximal end 31 of the base element 3 and configured to be axially moved to the locked position P2 towards the distal end 32 of the base element 3.

The spring elements 5 are at least partially arranged between the base element 3 and the outer sleeve 4. The second end 52 of the respective spring element 5 is deflected by a functional surface 41 of the outer sleeve 4. The functional surface 41 partially has the shape of a truncated cone. The smaller diameter of the truncated cone faces the proximal end 31 of the base element 3 whereas the larger diameter of the truncated cone is facing the distal end 32 of the base element 3. The spring elements 5 are in the locked position P2 of the outer sleeve 4 deflected and form an undercut UC with the mating connector 2 to secure the connector 1 and the mating connector 2 along the longitudinal axis x.

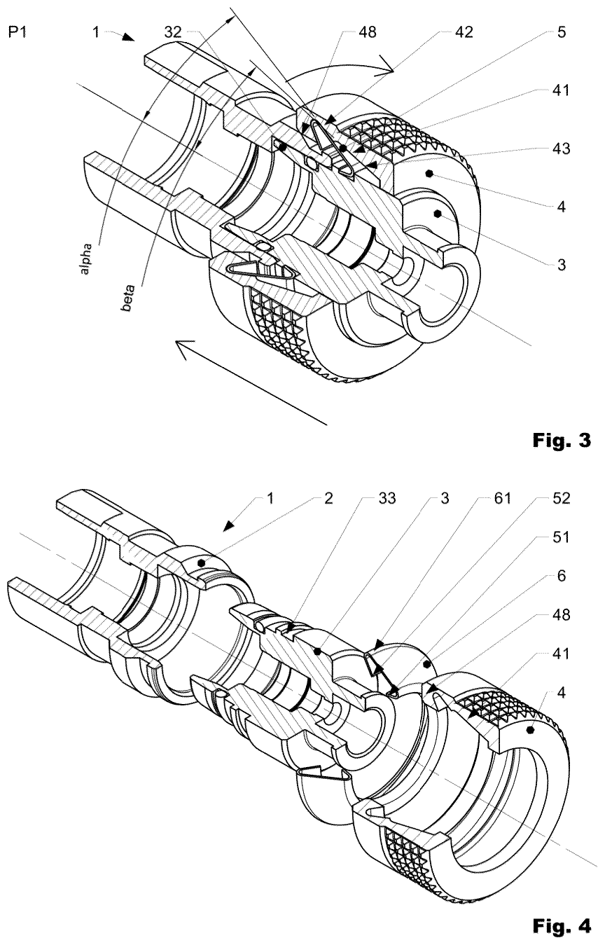

FIGS. 1 to 4 show a first embodiment of the connector 1. As can be obtained from FIGS. 3 and 4, the shown functional surface 41 comprises a first functional area 42 and a second functional area 43, which functional areas 42, 43 are both in the shape of a truncated cone. The shown first functional area 42 comprises a steeper slope angle α than the slope angle β of the second functional area 43. In the unlocked position P1, the spring element 5 interacts with the first functional area 42, whereas in the locked position P2 the spring element 5 interacts with the second functional area 43. As can be obtained from FIG. 2, the shown spring element 5 is thereby compressed and exerts a superimposed axial and radial force onto the mating connector 2. By axially displacing the outer sleeve 4 towards the distal end 32 of the base element 3, the spring element 5 is forced from the first functional area 42 into the second functional area 43. The outer sleeve 4 comprises a locking means 48, which is configured to engage the mating connector 2 during the rotation to secure the connector 1 and the mating connector 2 with respect to each other. In FIGS. 1 and 2, the locking means 48 are shown only schematically. They can for instance be realized as threads or as part of a bayonet lock. In FIGS. 3 and 4, the locking means are omitted altogether.

As apparent from FIG. 4, the shown spring element is in form of a spring ring 6, which comprises a C-shaped cross-section along the longitudinal axis. The first end 51 of the spring ring 6 is arranged in a circumferential recess 33 in the base element 3. The second end 52 of the spring ring 6 is foreseen to engage the mating connector 2. The spring ring 6 comprises an apex 61 between the first end 51 and the second end 61, which apex 61 engages with the functional surface 41 of the outer sleeve. During the axial motion of outer sleeve 4 with respect to the base element 4 from the unlocked position into the locked position, the outer sleeve 4 moves the apex 61 of the spring ring 6 from the first functional area 42 to the second functional area 43, whereby the spring ring 6 is compressed by the second functional area 43 and forms un undercut with the recess 33 in the base element 3.

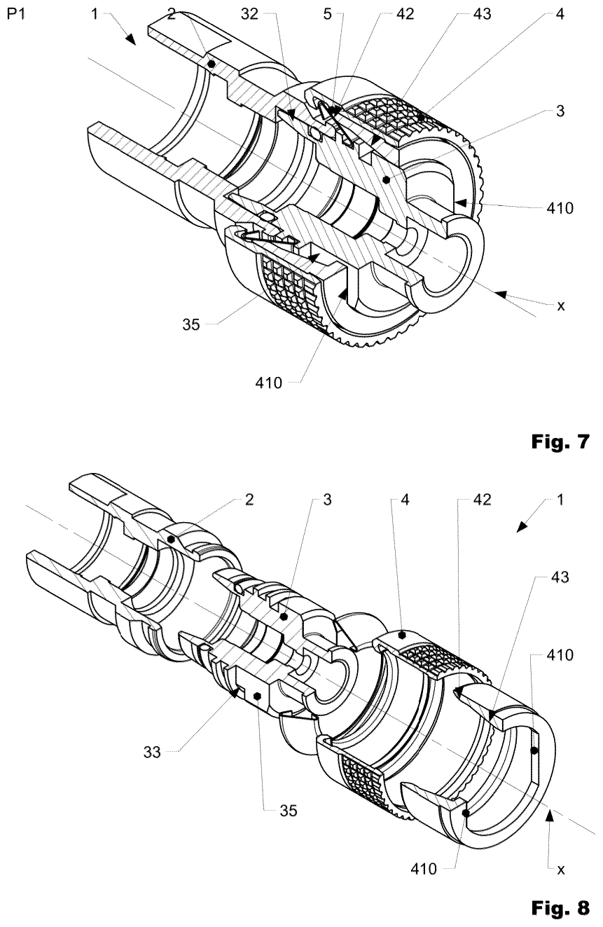

FIGS. 5 to 8 show a second embodiment of the connector 1. As can be obtained from FIGS. 7 and 8, the second embodiment essentially corresponds to the first embodiment. The main difference between the second embodiment and the first embodiment is in the design of the outer sleeve 4. The shown outer sleeve 4 is a multi-piece part. As can be seen in FIG. 6, the outer sleeve 4 comprises at the proximal end an anti-rotation means 49, which in the locked position engages a recess 33 in the base element 3. As can be obtained from FIGS. 7 and 8, the anti-rotation means 49 are in form of two protrusions 410 arranged with respect to the longitudinal axis x opposite to each other and during the movement of the outer sleeve 4 from the unlocked position into the locked position P2 slide over the outer surface 35 of the base element 3 before engaging the recess 33 in the locked position by rotation of the base element 3.

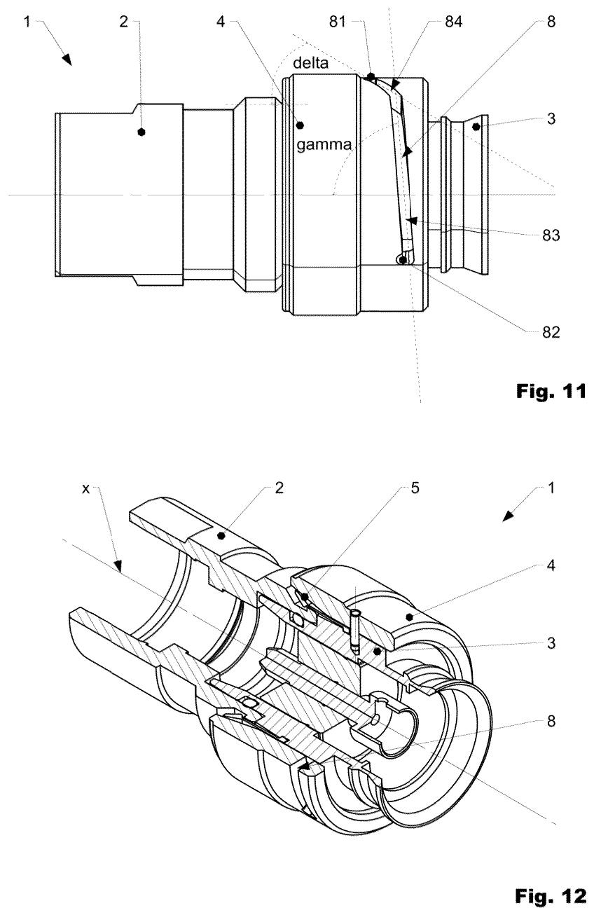

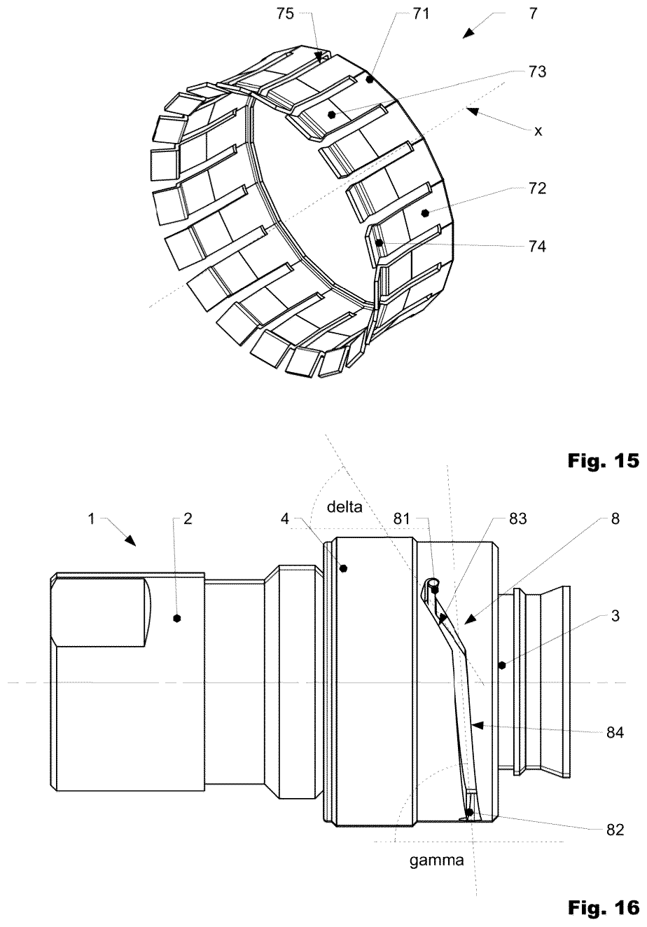

FIGS. 9 to 16 show a third embodiment of the connector 1. As can be obtained from FIGS. 11 to 14, the shown connector differs from the first embodiment and the second embodiment in the design of the outer sleeve 4 as well as the design of the spring element 5. As can be obtained from FIG. 14, the shown spring element is a circumferential spring cage 7, which comprises a tubular base 71 and a number of spring lugs 72 extending away from the base 71 parallel to the longitudinal axis x. The tubular base 71 is in form of a cylindrical ring. Each of the number of spring lugs 72 comprises an elastic stay 73, which is at a proximal end attached to the tubular base 71 and comprises at a distal end a projection 74. The distal ends of the spring lugs 72 are bent away from the longitudinal axis x. The projection 74 of each of the spring lugs 72 projects towards the longitudinal axis x. FIG. 15 shows a second variation of the spring element in form of a circumferential spring cage 7. The shown spring cage 7 differs from the variation shown by FIG. 14 in that it is made by stamping and bending. The spring cage 7 is bent from a flat sheet into its shown shape, with a gap 75 remaining between the initial ends of the tubular base 71. To support pushing the sleeve 4 in the unlocked position towards the proximal end 31 of the base element 3, some, e.g. 3 of the spring lugs 72 may be bent slightly outwards from the longitudinal axis x, so that they push against the functional surface 41 and generate a force on the sleeve 4.

As can be obtained from FIGS. 11 and 16, the shown outer sleeve 4 comprises a slot guide 8, which extends partially circumferential from a first pocket 81 to a second pocket 82. The pockets 81, 82 are each configured to secure the outer sleeve 4 in the unlocked position, respectively the locked position. Securing the outer sleeve 4 especially in the locked position with respect to the longitudinal axis x ensures that the spring element properly engages the mating connector 2. The slot guide 8 comprises a first segment 83 which extends from the first pocket 81 to a second segment 84 extending to the second pocket 82. The angle γ of the first segment 83 is steeper than the angle δ of the second segment 84, with respect to the longitudinal axis x. The slot guide 8 causes superimposed axial and rotational movement of the outer sleeve 4 with respect to the longitudinal axis x.

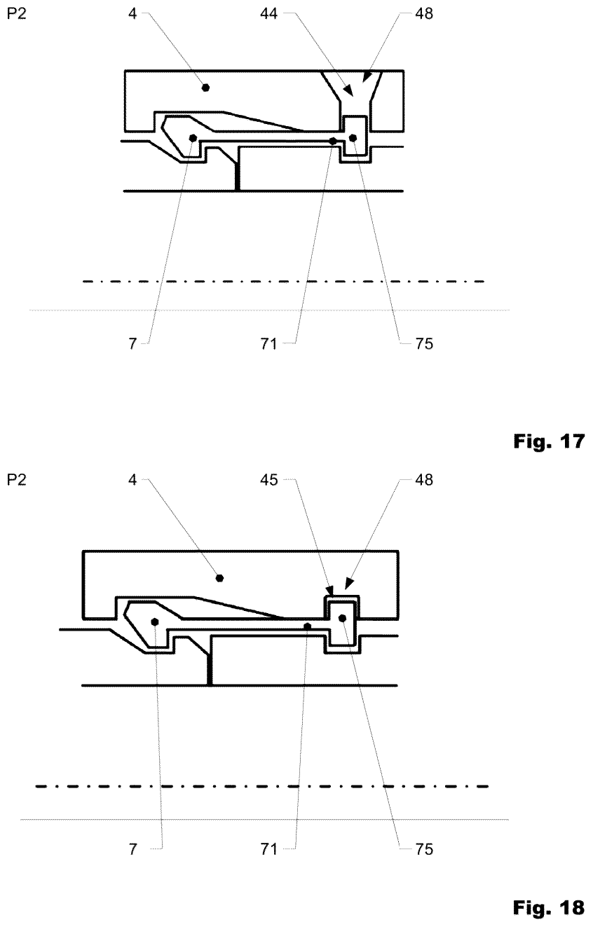

FIGS. 17 and 18 show a fourth and a fifth embodiment of the connector 1 in the locked position P2. In addition to the third embodiment, the outer sleeves 4 of the fourth and fifth embodiment each comprise a locking means 48. The spring cage 7 of the fourth and fifth embodiment each comprises at least one protrusion 75 which extends radially away from the tubular base 71. The outer sleeve 4 of the fourth embodiment comprises a window 44. The outer sleeve 4 of the fifth embodiment in comparison comprises a pocket 45. In the locked position P2, the shown protrusion 75 engages the window 44, respectively the pocket 45. The protrusion 75 typically serves the purpose of securing the outer sleeve 4 in the locked position P2 with respect to the longitudinal axis x.

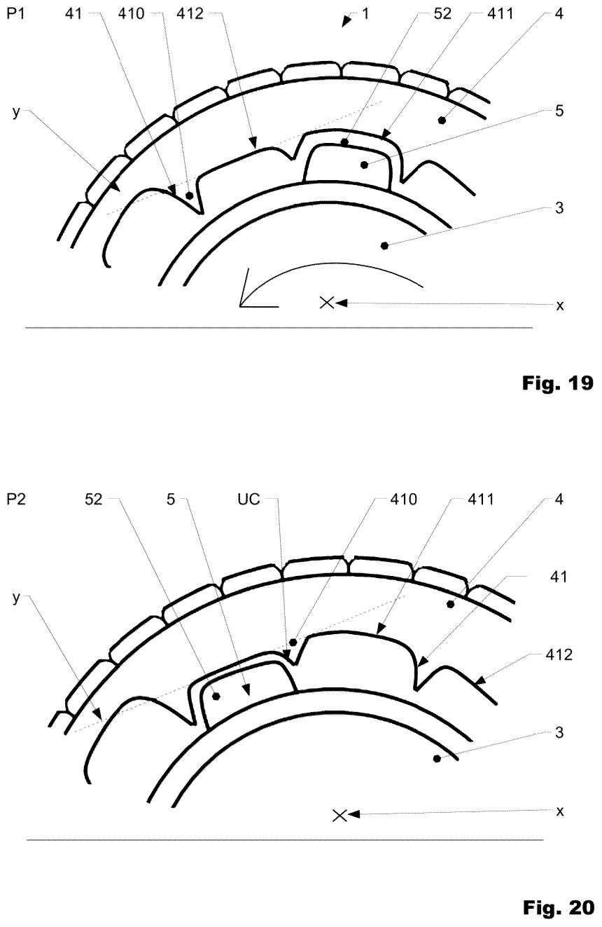

FIGS. 19 and 20 show a sixth embodiment of the connector 1. The shown connector 1 is also configured to be connected with a mating connector. The connector comprises a base element 3, which extends along the longitudinal axis x from a proximal end to a distal end. The base element 3 is designed similar to the base element of the first embodiment described above noted. The connector 1 further also comprises an outer sleeve 4, which is arranged circumferentially around the base element 3 and is configured to be moved with respect to the base element 3 between an unlocked position P1, as shown by FIG. 19 to a locked position P2 as shown by FIG. 20.

The connector 1 further comprises a spring element 5, which comprises a first end, which is interconnected to the base element 3, and a second end 52, which is configured to engage with the mating connector. The outer sleeve 4 is configured to be rotated around the longitudinal axis x from the unlocked position P1 to the locked position P2, in which the outer sleeve 4 acts on the spring element for the second end 52 of the spring element 5 to engage with the mating connector to hold the mating connector in a mated state against a pull-out force.

The shown spring element 5 is at least partially arranged between the base element 3 and the outer sleeve 4 and the second end 52 is deflected by the functional surface 41 of the outer sleeve 4. The outer sleeve 4 comprises protrusions 410 extending towards the longitudinal axis x. Each protrusion 410 comprises a functional surface 41, which in a cross-sectional view along the longitudinal axis x is at least partially inclined with respect to a tangential direction y. The shown outer sleeve 4, comprises circumferentially at its inner side first grooves 411 and second grooves 412, which extend parallel to the longitudinal axis x, whereby the first grooves 411 are deeper than the second grooves 412. The first grooves 411 and the second grooves 412 are arranged in alternating manner. Between each first groove 411 and each second groove 412 a protrusion 410 is arranged.

In the cross-sectional view along the longitudinal axis, each protrusion 410 has an essentially triangular layout. By rotating the outer sleeve 4 from the unlocked P1 into the locked position P2, the spring element 5 is compressed by the second grooves 412. The protrusions 410 prevent the spring element 5 from disengaging under an axial load. In the unlocked position P1, the second ends 52 of the spring elements 5 are movably arranged in the first grooves 411 and in the locked position P2 the second ends 52 of the spring elements 5 are deflected and form an undercut UC with the second grooves 412 for holding the mating connector in a mated state.

Rather, the words used in the specification are words of description rather than limitation, and it is understood that various changes may be made without departing from the Spirit and scope of the disclosure.

1. A connector for mating with a mating connector, the connector comprising:
a base element extending along a longitudinal axis from a proximal end configured to be interconnected to a cable, to a distal end configured to mate with the mating connector;
an outer sleeve which is arranged circumferentially around the base element and configured to move with respect to the base element between an unlocked position and a locked position;
at least one spring element comprising a first end interconnected to the base element and a second end configured to engage with the mating connector; wherein:
the outer sleeve is configured to be axially moved from the unlocked position to the locked position, in which the outer sleeve acts on the spring element so that the second end of the spring element engages with the mating connector for holding the mating connector in a mated state against a pull-out force, and
the outer sleeve is configured to be rotated around the longitudinal axis to be axially secured in the locked position.

2. The connector according to claim 1, wherein the outer sleeve in the unlocked position is arranged adjacent to the proximal end of the base element and configured to axially move to the locked position towards the distal end of the base element.

3. The connector according to claim 1, wherein the spring element in the locked position of the outer sleeve is deflected and forms an undercut with the mating connector for holding the mating connector in a mated state.

4. The connector according to claim 1, wherein the outer sleeve comprises a locking means configured to engage the mating connector through the rotation to axially secure the outer sleeve in the locked position.

5. The connector according to claim 1, wherein the spring element is at least partially arranged between the base element and the outer sleeve, and the second end is deflected by a functional surface of the outer sleeve.

6. The connector according to claim 5, wherein the functional surface is at least partially the shape of a truncated cone.

7. The connector according to claim 6, wherein the functional surface comprises a first functional area and a second functional area, the first and second functional areas each shaped as a truncated cone, with the first functional area comprising a steeper slope angle than a slope angle of the second functional area.

8. The connector according to claim 1, wherein the spring element is an at least partially circumferential spring ring comprising a C-shaped structure along the longitudinal axis.

9. The connector according to claim 8, wherein the spring ring comprises an apex between a first end and a second end, the apex engaging with the functional surface of the outer sleeve, wherein during the axial motion the outer sleeve is configured to move the apex of the spring ring from the first functional area to the second functional area, whereby the spring ring is compressed by the second functional area.

10. The connector according to claim 1, wherein the outer sleeve comprises at the proximal end an anti-rotation element which in the locked position engages a recess in the base element.

11. The connector according to claim 10, wherein the anti-rotation element comprises two protrusions arranged, with respect to the longitudinal axis, opposite to each other, and during the movement of the outer sleeve from the unlocked position into the locked position slide over the outer surface of the base element before engaging the recess in the locked position by rotation against the base element.

12. The connector according to claim 1, wherein the spring element is an at least partially circumferential spring cage comprising a tubular base and a plurality of spring lugs extending away from the base along the longitudinal axis.

13. The connector according to claim 1, wherein the outer sleeve comprises a slot guide extending at least partially circumferential from a first pocket to a second pocket each configured to secure the outer sleeve in the unlocked position or in the locked position.

14. A connector for mating with a mating connector, the connector comprising:
a base element extending along a longitudinal axis from a proximal end being configured to be interconnected to a cable, to a distal end being configured to mate with the mating connector;
an outer sleeve arranged circumferentially around the base element and configured to move with respect to the base element between an unlocked position and a locked position;
at least one spring element comprising a first end interconnected to the base element and a second end configured to engage with the mating connector, wherein the outer sleeve is configured to rotate around the longitudinal axis from the unlocked position to the locked position, in which the outer sleeve acts on the spring element for the second end of the spring element to engage with the mating connector to hold the mating connector in a mated state against a pull-out force.

15. The connector according to claim 14, wherein the outer sleeve is brought from the unlocked position to the locked position by a rotation around the longitudinal axis without an axial movement.

16. The connector according to claim 14, wherein the outer sleeve comprises protrusions extending inwards towards the longitudinal axis, each of the protrusions comprising a functional surface which in a cross-sectional view along the longitudinal axis and at least partially inclined with respect to a tangential direction.

17. The connector according to claim 16, wherein the outer sleeve comprises circumferentially at its inner side first grooves and second grooves separated by the protrusions, which first grooves and second grooves extend parallel to the longitudinal axis, whereby the first grooves are deeper than the second grooves.

18. The connector according to claim 17, wherein in the unlocked position the second ends of the spring elements are movably arranged in the first grooves and in the locked position the second ends of the spring elements are deflected and form an undercut for holding the mating connector in a mated state.

19. A coaxial connector assembly comprising a connector according to claim 1 and a mating connector.

20. A method for establishing a connection between a connector according to claim 1 and a mating connector.
